(19) United States
(12) Patent Application Publication
(10) Pub. No.: US 2006/0242899 A1
(43) Pub. Date: Nov. 2, 2006

(54) Method of cultivating plants

(76) Inventor: Christopher G. Parmenter, Arundel (AU)

Correspondence Address: ROETZEL AND ANDRESS, 222 SOUTH MAIN STREET, AKRON, OH, 44308, US

(21) Appl. No.: 11/438,750

(22) Filed: May 17, 2006

Related U.S. Application Data
(63) Continuation-in-part of application No. PCT/AU04/01516, filed on Nov. 2, 2004.

(30) Foreign Application Priority Data
Nov. 17, 2003 (AU) 2003906309

(51) Int. Cl. A01G 7/00; A01D 91/00; A01C 14/00

(52) U.S. Cl. 47/58.1 R; 111/200

(57) ABSTRACT

A method of cultivating plants including the step of harvesting the plant at a time within a period of 5 days prior to a lunar apogee and 5 days after the lunar apogee.

### FIELD OF THE INVENTION

The present invention relates to a method of cultivating plants and in particular to a method of cultivating plants to maximise the nutritional and medicinal potency of extracts from plants, particularly medicinal herbs.

### BACKGROUND ART

As a plant group, herbs are non-woody annuals, perennials and biennials. They contain chemicals, generally resins, in their seeds, flowers, leaves, fruits or roots that enhance their flavour or aroma. Recently gardeners have become more interested in growing and using herbs. Although herbs are fashionable now, herb gardens and uses of herbs have existed since ancient times. Ancient peoples used herbs as medicines. Many modern medicines are derived from plants. The resin strength is generally termed “potency”.

The potency of a particular herb sample will vary because of many factors other than the variety. Many of these have to do with the natural development of the plants and their resin glands. Environmental factors do affect potency but there are large differences in any variety.

Variations in Potency Within Varieties

There are noticeable differences in resins concentrations between plants of the same variety. Differences are sometimes large enough so that a user can tell (by taste) that certain plants are better. Five-fold differences in resin concentration have also shown up in research. However, when a group of plants of the same variety are considered, the resin concentrations are relatively similar.

Variations by Plant Part

The concentration of resin depends on the plant part, or more specifically, the concentration and development of resin glands to plant part. Female flower bracts generally have the highest concentration of resin glands and are usually the most potent plant parts. Seeds and roots have no resin glands. These show no more than traces of resin.

The potencies, in descending order, of the various plant parts are as follows:

1. Female flowering clusters.

2. Male flower clusters.

3. Growing shoots.

4. Leaves
a. that accompany flowers (small);
b. along branches (medium);
c. along main stem (large).
Generally, the smaller the leaf is, the more potent it can be.

5. Petioles (leaf stalks). Same order as leaves.

6. Stems. Same order as leaves. The smaller the stem (twig), the higher the possible concentration of resin.

7. Seeds and Roots.

This order is fairly consistent. The exceptions can be the small leaves that accompany male flowers which are sometimes more potent than the flowers themselves. The growing shoots are sometimes more potent than the mature female flowers.

Samples of pollen show varying amounts of resin. Resin glands are generally found inside the anthers, alongside the developing pollen grains.

Potency by Position on Plant

The potency of resin on any plant increases toward the top of the plant. The bottom-most leaves on the main stem are the least potent of the useable material.

Like almost all characteristics of these plants, considerable variation occurs even among siblings. Generally the better the quality of the variety, the steeper the gradient; in other words, the bigger the difference between top and bottom leaves.

Potency by Sex

Either a male or a female individual may have the highest concentration in any particular case. The largest variation is in comparing the flowers. Male flowers may be comparable to the females, or may be much weaker.

Potency by Age

In general, the longer the life cycle of the plant, the more the concentration of resins increases, as long as the plant stays healthy and vigorous. Generally, it is the development of the plant, rather than chronological age, that determines this difference in potency. A plant that is more developed or more mature is generally more potent.

A six-month-old plant will generally be better than a four-month-old plant, both of which are flowering. Plants eight months old will usually be more potent than six-month-old plants. Plants older than 10 months often develop abnormally. There is usually a decline in vigour and a loss in potency. However, some growers have decorative plants several years old.

Outdoor growers more often simply allow the plants to develop according to the local growing conditions which will govern their development and flowering time. Where the growing season is short, some growers start the plants indoors and transplant when the local growing season begins. This gives the plants a longer growing season.

One reason female plants are considered more potent is because of age. Males often flower in four to five months and die, while the females may continue to a ripe old age of eight or nine months, especially when they are not pollinated.

Potency by Growth Stage

Although the general trend is for the resin concentration to increase with age, this is not a matter of the simple addition or accumulation of resins. The concentration of resin changes with the general metabolic rate of the plant and can be related to the plant's growth pattern or life cycle.

Potency is an important factor in all plant-based extracts such as food, vitamins and medicines, with 8 main attributes determining the quality of the substance or product.

1. Strength—The strength of a standard dose establishes the amount of dosage needed.

2. Length—The “effective” length of a standard dose establishes the frequency of a dosage.

3. Tolerance—Tolerance determines whether the standard dose will remain effective with long-term use.

4. Effects—The effects experienced from an extract can vary dramatically depending upon the potency of the extract.

5. Oils and Resins—Oil production and content increases with potency.

6. Taste, flavour and aroma—Taste, flavour and aroma all vary in relation to the potency.

7. Nutrients—Maximum nutrient content occurs as the metabolic conversion of oils into resins takes place.

8. Shelf Life—The shelf life of produce is linked to maximum nutrient content.

One important note is that the potency of the herb can decrease as well as increase during the plant's life cycle. Actual studies of the cyclic variations in potency over the course of a season have shown very complicated rhythms.

There is therefore a highly complicated rhythm which a resin concentration undergoes during a plant life cycle.

There is therefore a need for a method of cultivating or growing plants, particularly medicinal herbs which will allow a maximization of the resin concentration and/or potency of the herb in order to maximize the growing efficiency of the herb. In this way, a grower need have fewer plants to gain a specified amount of resin extract or increase their crop yield by planting the same amount of a higher yielding plant.

Generally in the past, herbs and the like have been picked according to growth phases or according to development stages such as a colour change in the trichomes of the plant.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a method of cultivating plants, which may at least partially overcome at least one of the abovementioned disadvantages or provide the consumer with a useful or commercial choice.

In one form, the invention resides in a method of cultivating plants including the step of harvesting the plant at a time within a period of 5 days prior to a lunar apogee and 5 days after the lunar apogee.

In use, the method is adapted to allow a user to maximise the potency of the chemical constituents of the plant which are or may be useful as or in medicines or foods.

Preferably, harvesting may take place on the day of the lunar apogee. At the lunar perigee, no harvesting may take place. The lunar cycle may repeat every approximately 27 days and the harvesting may take place within a ten day window around the lunar apogee.

The method of the present invention finds particular application to increasing the potency of herbs, particularly those with nutritional, medicinal or pharmacological uses, but may be adapted to use with any plant variety. The inventor has found that the method according to the present invention is particularly adapted to application to the growth and harvesting of herbs, vegetables, fruits, sugar cane and tobacco growing.

Generally herbs are used for their chemical constituents and said useful constituents may be of different types for different herbs. For example, a given herb may be useful for its flavonoids or cannaboids.

Whilst not wishing to be limited by theory, the orbit of the Moon is very nearly circular (eccentricity ˜0.05) with a mean separation from the Earth of about 384,000 km, which is about 60 Earth radii. The plane of the orbit is tilted about 5 degrees with respect to the ecliptic plane. The Moon appears to move completely around the celestial sphere once in about 27.3 days as observed from the Earth. This is called a sidereal month and reflects the corresponding orbital period of 27.3 days. The moon takes 29.5 days to return to the same point on the celestial sphere as referenced to the Sun because of the motion of the Earth around the Sun; this is called a synodic month (Lunar phases as observed from the Earth are correlated with the synodic month). It is also to be noted that the phases of the moon are very different and separate from the apogee and perigee of the moon which have a 27.6 day cycle.

The principal area in which research was undertaken deals with Gravity, Magnetism and how the four main lunar cycles affect plants and plant potency in various ways, and how all the cycles are interconnected.

The Lunar Cycles, Gravity, Magnetism, their Duration and Effects.

1. Gravity and Magnetism (Effects both outdoor and indoor cultivation)

2. Inclination Band Lateral movement=Balance (Effects both indoor and outdoor cultivation)

3. Phases Full and New Moon 29.5 days=Growth (Effects outdoor cultivation only)

4. Tides Daily Rotation 24.50 hours=Feeding (Effects both outdoor and indoor cultivation)

5. Elliptic Perigee to Apogee 27.6 days=Potency (Effects both outdoor and indoor cultivation)

### Gravity and Magnetism

The magnetic and gravitational forces generated by the Earth, Moon and Sun all combine to influence plants in various ways. The Earth has the strongest gravitational attraction due to proximity and mass. The Sun's gravitational pull is much weaker, enhancing the lunar cycles on new and full Moons and also determining the elliptical lunar orbit.

Gravity and magnetism work together causing the tides and controlling the feeding cycles of plants. The amount of force that gravity exerts is constantly changing and its effect can be easily observed in the variation between high tide levels. The Earth's gravitational force is increased by as much as 30% when there is an anchoring object such as the Moon. There are also large differences in gravitational force when the Moon is at Perigee, compared to the Apogee.

Gravitational forces are at their greatest when the Moon is at Perigee and as the Moon moves toward Apogee the gravitational forces ease considerably. The change in gravitational force causes the Earth to expand as the Moon travels toward the Apogee and then contract as the Moon travels back to Perigee. This movement causes the Earth's tectonic plates to move resulting in the majority of earthquakes occurring midway between the Apogees and Perigees.

Magnetism forces remain virtually constant but when the Moon is at Apogee, the gravitational forces are much weaker and greatly increases water uptake in all plants. The decreased gravitational forces on the Apogee also result in the majority of volcanoes erupting on or near the Apogee. The Apogee of the Moon may also be the main trigger that causes coral to spawn.

Gravitation forces on the opposite side of the earth have no anchor and therefore are much weaker. The Earth's rotation combines with the weaker gravitational force to produce a reflex tide and also allows plants to draw up water and nutrients, which is their daily feeding cycle.

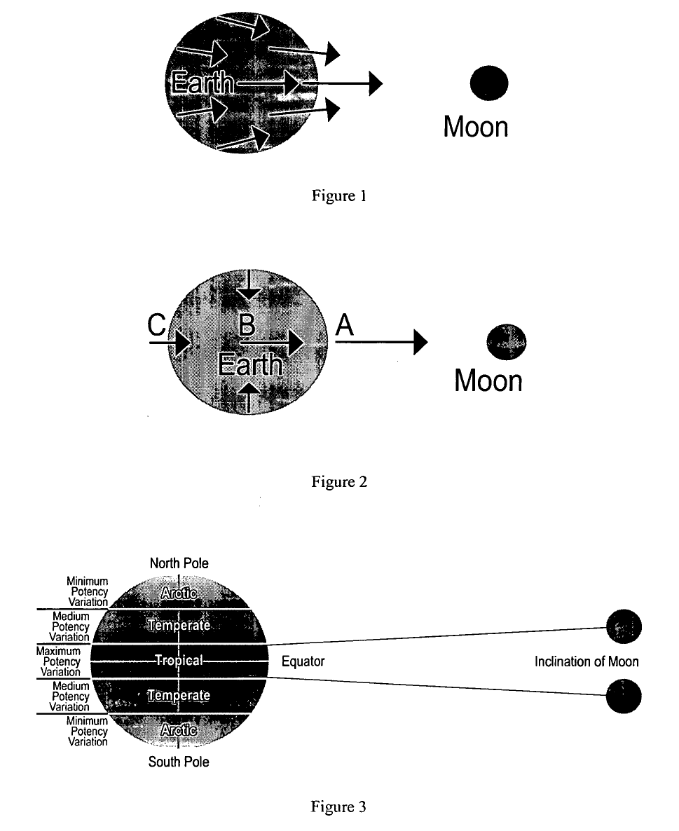

Gravity and magnetism affect both indoor and outdoor cultivation. FIGS. 1 and 2 illustrate how the Earth's gravitational forces are directed toward and attracted to, the moon. Positions (A, B and C) show the differences in gravitational force at different positions on the Earth, (A) being the strongest.

Due to the position of the North and South Poles, in relation to the Moon and Earth's rotation, the gravitational and magnetic forces are much weaker in the Arctic regions thereby producing a smaller variation (minimum to maximum) in plant potencies. Maximum variations in plant potency levels will only occur in the tropical and temperate regions where Earths rotation combined with gravitational and magnetic forces are at their strongest. Average Variations: Arctic=5%-15%, Temperate=5% -25%, Tropical=5%-35% and are illustrated in FIG. 3.

### The Lunar Cycles

Inclination Band

A wobbling effect is created by the elliptical orbit of the moon and is called the Inclination Band. This wobbling effect spreads and balances the gravitation and magnetic forces evenly over the tropical and temperate areas of the Earth.

Phases

The synodical Moon rhythm is the best-known lunar cycle as the phases are obvious and clearly visible, showing the phases of reflected sunlight between the Full and New Moon, which orbits the Earth every 29.5 days.

This cycle influences growth in all plants, producing far higher germination rates when planting takes place at the New Moon, and greatly increasing yields when harvesting on the Full Moon. The quantity of light reflected by the Moon is 30% greater when the Full Moon falls on the Perigee, compared to the Apogee.

This cycle does not affect indoor cultivation where artificial lighting is used. This cycle does not control water uptake or potency in plants.

Tides

Viewed from above the North Pole the Earth rotates in an anti-clockwise direction once every 24 hours. The Moon rotates in the same direction and travels faster than the earth but because of the distance between the Moon and the Earth, it takes 24.50 hours, for the Moon, to complete one rotation, when viewed from a fixed position on Earth. The differing times and speeds of these rotations, combined with magnetic forces and gravitational pull, create a dragging effect which causes the tides.

The gravitational pull on that part of the Earth nearest the Moon draws the Moon close and the magnetism raises the tide, which lags behind by about 1 hour and is balanced by a 30% lower reflex high tide on the opposite side of the Earth. Spring tides occur on the New and Full Moons, when the Sun and Moon align in conjunction or opposition and combine their gravitational force. This cycle also controls how all plants feed and rest on a daily basis.

From a fixed position on the Earth, the distance between the Earth and the moon will fluctuate by 12756 km on a daily basis due to earth's rotation. The rotation combined with the elliptical orbit acts like a ladder with potency levels.

As the moon moves towards the apogee, potencies will increase with each daily rotation of the earth. Potency levels will decrease with each daily rotation of the Earth as the moon moves towards perigee.

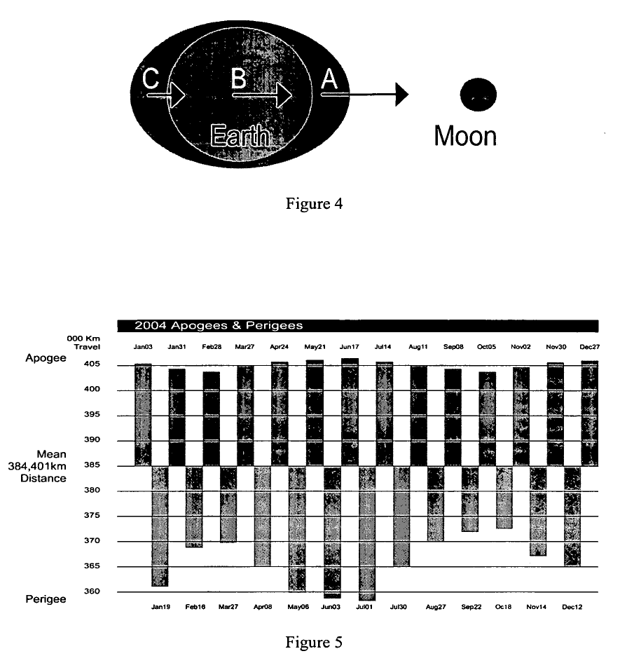

FIG. 4 illustrates how the Moons magnetism raises the tide (A). The reflex tide (C) is caused by Earths rotation and has a balancing effect. This cycle affects both indoor and outdoor cultivation.

Elliptical Orbit

The chart of FIG. 5 illustrates the differences in travel distance for each Apogee and Perigee for 2004.

As it circles the Earth, the Moon's elliptical orbit varies in distance by approximately 50,000 kilometres between Apogee and Perigee. This elliptical variation means that there are varying intensities of magnetic and gravitational attraction between the Earth and the Moon throughout the cycle, with maxima and minima occurring at Apogee and Perigee. The cycle has an average duration of 27.6 days, which is shorter than the Phase cycle by about 2 days, so the Apogee and Perigee are continuously advancing through the Phase cycle.

The position of the elliptical orbit determines all plant potencies by controlling the ability of plants to draw up and store vital trace elements in the form of oils and then convert them into resins. Potency matures on the Apogee as this metabolic conversion of oils into resins occurs. Each Apogee and Perigee differs in length and consequently produces slightly different potencies. In general, the further the Moon is away from the Earth, the higher the potency of the extract.

The Mean Distance is where potencies rise above the average 15% for about 10 days out of the 27.6 day cycle and potencies will rise to over 30% when harvested on the Apogee peak. Products that are harvested over the entire month will have extremely inconsistent potency levels due to when the majority of product was harvested in relation to the elliptical orbit of the Moon.

Due to this cycle, 6 week old plants that are harvested on the Apogee “will be far more potent” than fully matured plants that are harvested on the Perigee.

Due to the metabolic change that occurs during the Apogee, plant extracts that are harvested before the Apogee as oils will have very different effects than extracts that are harvested after the Apogee as resins. Flavour and aroma improves dramatically during this conversion of oils into resins and shelf life is dramatically increased.

This cycle controls potency for both indoor and outdoor cultivation.

Below are the predicted Apogee and Perigee peaks for 2004 and 2005 and the position of the Phase cycle in relation to each peak. All times are in UTC/GMT time and must be adjusted for individual time zones in different parts of the world.

| | |
|---|---|
| Perigee | Apogee |

2004 APOGEES AND PERIGEES

| | | | | | | | |
|---|---|---|---|---|---|---|---|
| | | | | Jan 3 | 20:20 | 405706 km | F − 3 d19 h |
| Jan 19 | 19:26 | 362767 km | N − 2 d 1 h | Jan 31 | 14:01 | 404806 km | F − 5 d18 h |
| Feb 16 | 7:35 | 368319 km | N − 4 d 1 h | Feb 28 | 10:46 | 404257 km | F − 7 d12 h |
| Mar 12 | 3:38 | 369509 km | F + 5 d 4 h | Mar 27 | 7:03 | 404519 km | N + 6 d 8 h |
| Apr 8 | 2:29 | 364547 km | F + 2 d15 h | Apr 24 | 0:27 | 405402 km | N + 4 d11 h |
| May 6 | 4:30 | 359811 km | F + 1 d 7 h | May 21 | 12:03 | 406261 km | N + 2 d 7 h |
| Jun 3 | 13:11 | 357248 km | F + 8 h | Jun 17 | 16:03 | 406574 km | N − 4 h |
| Jul 1 | 23:01 | 357449 km | F − 12 h | Jul 14 | 21:09 | 406191 km | N − 2 d14 h |
| Jul 30 | 6:27 | 360325 km | F − 1 d11 h | Aug 11 | 9:35 | 405290 km | N − 4 d15 h |
| Aug 27 | 5:38 | 365105 km | F − 2 d20 h | Sep 8 | 2:43 | 404462 km | N − 6 d11 h |
| Sep 22 | 21:13 | 369599 km | F − 5 d15 h | Oct 5 | 22:11 | 404326 km | F + 7 d 9 h |
| Oct 18 | 0:04 | 367757 km | N + 3 d21 h | Nov 2 | 18:10 | 404998 km | F + 5 d15 h |
| Nov 14 | 13:55 | 362312 km | N + 1 d23 h | Nov 30 | 11:26 | 405951 km | F + 3 d15 h |
| Dec 12 | 21:31 | 357985 km | N + 20 h | Dec 27 | 19:16 | 406487 km | F + 1 d 4 h |

2005 APOGEES AND PERIGEES

| | | | | | | | |
|---|---|---|---|---|---|---|---|
| Jan 10 | 10:08 | 356571 km | N − 1 h | Jan 23 | 18:55 | 406442 km | F − 1 d15 h |
| Feb 7 | 22:10 | 358563 km | N − 1 d 0 h | Feb 20 | 5:00 | 405805 km | F − 3 d23 h |
| Mar 8 | 3:43 | 363234 km | N − 2 d 5 h | Mar 19 | 22:55 | 404847 km | F − 5 d22 h |
| Apr 4 | 11:11 | 368490 km | N − 4 d 9 h | Apr 16 | 18:42 | 404302 km | F − 7 d15 h |
| Apr 29 | 10:00 | 369028 km | F + 4 d23 h | May 14 | 13:42 | 404600 km | N + 6 d 4 h |
| May 26 | 10:44 | 364240 km | F + 2 d14 h | Jun 11 | 6:13 | 405505 km | N + 4 d 8 h |
| Jun 23 | 11:50 | 359674 km | F + 1 d 7 h | Jul 8 | 17:40 | 406362 km | N + 2 d 5 h |
| Jul 21 | 19:46 | 357159 km | F + 8 h | Aug 4 | 21:50 | 406629 km | N − 5 h |
| Aug 19 | 5:33 | 357395 km | F − 12 h | Sep 1 | 2:36 | 406209 km | N − 2 d16 h |
| Sep 16 | 13:59 | 360405 km | F − 1 d12 h | Sep 28 | 15:21 | 405306 km | N − 4 d19 h |
| Oct 14 | 13:51 | 365449 km | F − 2 d22 h | Oct 26 | 9:36 | 404492 km | N − 6 d15 h |
| Nov 10 | 0:16 | 370013 km | F − 6 d 0 h | Nov 23 | 6:19 | 404370 km | F + 7 d 5 h |
| Dec 5 | 4:33 | 367364 km | N + 3 d13 h | Dec 21 | 2:50 | 405013 km | F + 5 d10 h |

In a particularly preferred form, the present invention includes the steps of planting the plant and calculating the harvesting time of a mature plant to coincide with the lunar apogee.

In this way, a single plant may undergo more than one repeating cycle of potency, the cycle of potency of the chemical constituents being approximately as follows:

1. Very low potency at or around the time of lunar perigee, the potency increasing as the lunar apogee approaches;

2. Approximately 5 days before the lunar apogee, the potency of the plant begins to peak;

3. At or around the time of apogee, the potency reaches its peak;

4. Within approximately 5 days after the lunar apogee, the potency is falling but remains above an acceptable level.

The chemical constituents of a plant harvested within the ten day period as defined by the invention may vary depending upon the harvesting time within the period. For example, the inventor has found that the chemical constituents have slightly different compositions before and after the lunar apogee and therefore may have slightly different uses.

Definitions of certain terms used herein are as follows:

Apogee—apoapsis in Earth orbit; the point in its orbit where a satellite is at the greatest distance from the Earth.

Apoapsis—the point in an orbit farthest from the body being orbited.

Perigee—periapsis in Earth orbit; the point in its orbit where a satellite is nearest to the Earth.

Trichome—an outgrowth from an epidermis; a hair or scale which may be unicellular or multicellular, branched or unbranched, secretory, absorbing or non-functional.

### DETAILED DESCRIPTION OF THE INVENTION

According to the present invention, a method for cultivating plants is provided.

The inventor undertook an assessment of the method according to the invention in order to test its validity.

There are many different ideas of how to harvest maximum potency but none of them explain why the potency levels fluctuate so much. The cycle has the same effect on indoor and outdoor plants and potency can be tested at any stage of growth (leaf or bud). The cycle repeats itself approximately every 27.6 days.

### The Test

The tests were done by taking samples from a number of plant varieties, at different times, in relation to the elliptical orbit of the moon.

In order to get a good comparison multiple samples were taken on the Apogee and Perigee from numerous plants and varieties. The samples for each individual plant were stored and then tested against each other to provide a comparison in potency levels.

The potency effects were then recorded and analyzed with the following types of data recorded:

1. date and position of moon

2. strain of plant

3. indoor or outdoor

4. type of sample—leaf, flower, fruit, vegetable or herb

5. sample strength and length—chemical

6. size of sample

7. oil or resin content

8. taste, flavour and aroma

9. effects and tolerances

10. shelf life

All the test results were then compared to determine the elliptical cycle's effect on plant potency.

The results of all the vegetables, fruits and herbs that were tested clearly show a consistent, uniform maturing cycle that matches the elliptical cycle of the moon.

A sample of the results is as follows:

1. Perigee—very low potency—bland, raw earthy taste with minimum flavour and aroma, very little resin or oils, very short shelf life.

2. Five days before Apogee—medium potency—oil content increases, taste, flavour, aroma and shelf life improves.

3. Apogee—very high potency—superb flavour, taste and aroma, maximum shelf life.

4. Five days after Apogee—medium potency—resins, taste, flavour, aroma and shelf life all decline sharply.

Further Tests Performed

Cannabis (Sativa and Indica)

To provide a reliable, consistent and effective medicinal action when employing cannabis, the strength of the dosage, type and duration of effect plus tolerance levels are all important parameters. The Moon's orbital position is an important and previously unconsidered factor in achieving these outcomes, causing the potency of cannabis to vary as much as between 5 and 35%.

Cannabis is a superb natural “medicine” for many different ailments especially pain relief.

A standardized dose was used in the experiments at all times to provide an accurate assessment of the potency attributes. Testing was conducted on plants cultivated both indoors and outdoors throughout all stages of growth and on numerous different varieties. All of the samples and tests exhibited the same effects of the elliptical orbit with only very slight differences between varieties.

At Perigee, the closest point of the Moon's orbit around the Earth, the plant has very low potency, usually containing less than 5% THC and exhibiting a distinctive, raw earthy taste. At this stage the cannabis has very little therapeutic effect and can even cause headaches if used often. A large dose of around 2 grams is required to be effective as medication and the effects wear off very quickly, usually within 1 hour. A patient quickly builds tolerance through regular use and thus render the medication ineffective. Consequently, cannabis should not be harvested and used at this stage of the potency cycle.

As the Moon begins to move away from the Earth towards its orbital Apogee and the magnetic and gravitational forces ease, plants are better able to draw up and store vital active elements in the form of oils, and the potency levels start to increase.

Five days before the Apogee fluid uptake increases, taste and aroma improves and potency rises to an average of 15% THC allowing for a smaller effective dose of about 1 gram. The therapeutic action lengthens, producing a mild cerebral, energetic, and appetizing effect that lasts 3 to 4 hours. A medium level of pain relief is achieved, especially in the upper body, but tolerance can still build up quickly if material picked at this time is used often.

Twenty-four hours before the Apogee, the oil content is at its highest level, making this the optimum time of harvesting for all oil-based products. Taste and aroma improves dramatically as potency rises to an average of 30% THC, allowing for a smaller effective dose of around ¾ gram. The cerebral, energetic and appetizing effect is now greatly increased, lasting 6 to 8 hours and providing excellent pain relief in the upper body. As the potency matures, it induces far less tolerance, providing an extremely consistent and effective medicine.

When the Moon reaches the Apogee and is furthest from Earth, potency reaches its maximum and the plants undergo a dramatic metabolic change whereby they convert their oils into resins. During this conversion of oils into resins, the tar content of cannabis when smoked is significantly reduced resulting in a very clean product. This conversion also delivers superb flavour and aroma due to the reduction of tars. The medicinal action also changes dramatically from a largely cerebral one to a full body effect that provides superb, tolerance free pain relief throughout the whole body. THC content and potency rises up to 35%, allowing for a smaller effective dose of ½ gram. The effects lengthen to over 10 hours and even with heavy long-term use, tolerance does not develop.

Twenty-four hours after the Apogee, all oils have been converted into resins, making this the optimum time for harvesting resin-based products. The THC content and potency falls slightly to about 30% as the magnetic and gravitational forces begin to increase again, requiring a slightly higher effective dose of approximately ¾ gram. The action changes to a strongly relaxing, sleepy, full body effect providing excellent pain relief in the lower body which lasts 6 to 8 hours. The potency, taste and aroma all decline sharply over the next 48 hours as the plants expel their resins and waste products. The resins dry out and weather away, while the efficiency reduces and tolerances begin to develop.

Five days after the Apogee, THC content and potency has dropped to approximately 15%, requiring a larger effective dose of 1 gram, and the taste and aroma continues to degrade as magnetic and gravitational forces increase. The relaxed, sleepy, full body effects provide medium levels of pain relief in the lower body that last 3 to 4 hours. Tolerance can build up very quickly if material picked at this time is used often.

As the Moon approaches the Perigee again, potency drops to about 5% THC content with very little medicinal action. The taste and aroma becomes raw and earthy again and a large effective dose of around 2 grams is required. The effects will only last about 1 hour and if used often tolerance can build up very quickly and the medication becomes ineffective. Cannabis should not be harvested or used at this stage of the cycle.

After harvesting the Cannabis, the plant should be trimmed and dried as quickly as possible to lock in the potency as potency will degrade with long drying periods.

This cycle repeats itself every 27.6 days, which allows multiple harvesting peaks, for maximum medicinal potency, throughout plant life.

### Stinging Plants

During research into Cannabis, frequent contact with the Giant Stinging Tree and the Stinging Nettle was made, and large differences in their stinging effects at different times of the month were observed. Potency testing of the stings against the lunar cycles was then undertaken and found to match the cycle predicted.

The Stinging Tree (Dendrocnide)

This plant should be avoided at all times as the stinging affect can last for many months. There has been one reported death attributed to it so protective clothing should always be worn when working near this plant.

At Perigee, the effect of the sting is a strong itchy, burning sensation that can last for many hours, and in some cases, for days.

The Taro plant or Elephant Ear that usually grows nearby will give relief by rubbing the sap from its root onto the affected area. The stinging hairs should be removed with wax hair removal strips. Rubbing the affected area should be avoided as this only pushes the tiny stinging hairs deeper under the skin.

At Apogee, the sting becomes unbearably painful, giving an extremely itchy, scalding effect which lasts for days and in some cases weeks. The Taro plant will only soothe the burning effect, and anti-histamine should be administered as soon as possible. The stinging hairs must be removed with wax hair removal strips to prevent the continued irritation which can last a lengthy period of days or months.

The Stinging Nettle (Urtica Dioica)

Traditionally the Stinging Nettle has many uses and is valued as a food, medicine and for its fibres.

At Perigee, it gives a mild sting with small lumps forming where the stings have penetrated the skin, similar to a group of mosquito bites. The sting produces an itchy burning sensation that generally wears off quickly. The sap of the Nettle, the Dock plant and the Taro plant, which all usually grow nearby will neutralize the stinging effect.

At Apogee, protective clothing should be worn as the sting becomes very painful, similar to red-hot needles touching the skin. The affected area becomes very itchy with a burning sensation that can last up to 24 hours.

### Sugar Cane

The harvesting season for sugar cane usually lasts about 26 weeks starting in June and finishing in December.

Sugar cane farms generally form a co-operative and employ a contract harvesting team for each area. The farms are put on a harvesting roster which is spread over the 26 week period allowing for 4 or more harvesting dates for each farm. This roster provides an equal basis for all farms to harvest maximum sugar content (CCS) which is constantly varying throughout the 26 week period.

The CCS content in sugar cane rises and falls in conjunction with the elliptical orbit of the moon, with the highest CCS content occurring on the Apogees. All the harvested sugar cane is mixed together and processed into raw sugar with no grading of potency or quality. The harvesting contractors and farmers are given a detailed report on all aspects of the harvest for efficiency purposes.

The CCS content varies greatly between different varieties of cane and also between 1 year old and 2 year old varieties. The older 2 year old sugar cane varieties hold their CCS content far better than 1 year old varieties and therefore have a higher CCS content at Perigee. The CCS content of both 1 and 2 year old varieties will rise significantly on every Apogee and fall on every Perigee and in so doing clearly shows how the elliptical cycle has a maturing effect on sugar cane.

Numerous samples of raw sugar were obtained from the processing mill on the Apogees and Perigees throughout the seasons for testing. The samples of raw sugar were a combination of many varieties so no comparisons could be made for individual varieties.

These samples were then tested for any variation in sweetness, potency and aftertaste. The tests were done by adding 2 teaspoons of raw sugar to a glass of water which was then taste tested; in the same manner wine is tested, with very distinctive results.

At Perigee (immature potency), the sugar cane's CCS content was at its lowest. These samples had a very distinctive, acidic aftertaste, due to the expulsion of resins and the uptake of oils. This aftertaste was constant and remained even when the tested sample amounts were increased.

Samples which were harvested on the Apogee (fully matured potency) with the sugar cane's CCS content registering its highest were consistently far sweeter in taste requiring 1½ teaspoons to give a similar taste. There was no aftertaste whatsoever from all the samples which were harvested on the Apogee. There was a significant, uniform difference in sweetness between all Perigee and Apogee samples.

No grading of the finished product is done in sugar mills and the raw sugar is simply stored in bulk for sale to refineries and distributors. This results in raw sugar having extremely inconsistent qualities because the content percentages of Perigee (immature potency) and Apogee (fully matured potency) cannot be determined. All plant extracts must be of the highest quality for use in research, medicines and pharmaceuticals. The grading of potency is critical for all plant extracts thereby giving a consistently effective platform base for research into medicinal and nutritional values.

### Garden Vegetables and Herbs

The taste, flavour and shelf life of all the vegetables improved significantly when harvested according to the method of the present invention, particularly with tomatoes, sweet corn, zucchinis, beans and carrots. Both fresh and dried herbs showed a dramatic improvement in all aspects of cooking and medicinal usage.

Many fruits have shown a dramatic increase in quality, flavour, sweetness and shelf life especially oranges, grapes, pineapples, mangoes, bananas and water melons when the method of the present invention is applied to harvesting.

All fruit juices have shown exceptional improvement particularly in sweetness and flavour. Fruit that is harvested on the Perigee have a very distinct bland, sour and acidic flavour and aftertaste particularly with pineapples and all types of citrus.

All the herbs harvested on the apogee according to the method of the present invention have shown a consistently far higher potency, quality and flavour than those harvested at any other time. Vegetables and herbs have a very bland, earthy taste and a far shorter shelf life when harvested on the Perigee. On the Apogee the taste is a rich and full bodied flavour which lingers on the taste buds. The differences are very noticeable when samples are taste tested, side by side.

### Pastures and Hay

Bales of hay harvested on the Perigee and Apogee were obtained from neighboring farms, then after curing were fed to the cattle to see which they preferred.

The bales were loosely spread on the ground about 10 feet apart, then the cattle were let into the yard and observations were made on which samples they preferred. Over a dozen tests were done with different cattle and varieties of hay.

On every test the cattle went straight to the Apogee samples and ate the entire sample before eating any of the Perigee samples. It was very clear that the cattle preferred the Apogee samples and they could tell difference between Perigee and Apogee samples by smell alone.

The potency cycle repeats these effects, in this order, approximately every 27 days. The up stage is a high potency, large amounts of resin and the down stage is almost no resin and low potency. The following table shows examples of prior art potency variations in fodder used for livestock. (Source: feed.test@dpi.vic.gov.au)

TABLE 1

| | | | | | | Neutral |
|---|---|---|---|---|---|---|
| | | | Crude | Dry Matter | Metabolisable | Detergent |
| | No. of | | Protein CP | Digestibility | Energy ME | Fibre NDF |
| Description | Samples | | (%) | DMD (%) | (MJ/kg DM) | (%) |
| Hay, Legume | 954 | Mean | 18.8 | 66.4 | 9.6 | 44.0 |
| | | Range | 6.4-28.0 | 42.5-81.7 | 5.7-12.0 | 30.4-71.0 |
| Hay, | 319 | Mean | 14.0 | 64.3 | 9.3 | 53.0 |
| Legume/Grass | | Range | 3.6-25.6 | 47.1-78.8 | 6.5-11.6 | 32.2-77.8 |
| (Legume | | | | | | |
| Dominant) | | | | | | |
| Hay, | 562 | Mean | 11.4 | 63.8 | 9.2 | 56.9 |
| Legume/Grass | | Range | 3.0-22.9 | 45.1-82.4 | 6.2-12.1 | 31.2-76.6 |
| (Grass | | | | | | |
| Dominant) | | | | | | |
| Hay, Grass | 94 | Mean | 9.4 | 61.0 | 8.7 | 61.9 |
| | | Range | 1.5-24.1 | 38.7-74.6 | 5.2-10.9 | 48.7-78.8 |
| Hay, Cereal | 1427 | Mean | 7.4 | 63.1 | 9.1 | 56.3 |
| | | Range | 1.3-19.8 | 34.8-78.0 | 4.6-11.4 | 34.6-84.9 |
| Hay, | 122 | Mean | 11.1 | 64.9 | 9.4 | 53.6 |
| Cereal/Legume | | Range | 5.2-26.8 | 45.4-79.6 | 6.2-11.7 | 33.4-73.4 |

### Crude Protein (CP)

Crude protein is the amount of true protein (composed of amino acids) and non-protein nitrogen in the feed.

### Dry Matter Digestibility (DMD)

Is the percentage of the feed dry matter actually digested by animals, estimated using a laboratory method which is standardised against DMD values from feeding trials. High quality feeds have a DMD of over 65%, whilst feeds below 55% DMD are of poor quality and will not maintain live weight even if stock have free access to it.

### Metabolisable Energy (ME)

Is the feed energy actually used by the animal, calculated from DMD and expressed as megajoules per kilogram of dry matter (MJ/kg DM). ME is the most important figure on the report. It is used to calculate whether stock are receiving adequate energy for maintenance or production.

### Neutral Detergent Fibre (NDF)

Estimates the total cell wall content in a feed, and is the most useful measure of fibre content currently available.

Table 2 shows the Australian Fodder Industry Association Grades for Legume and Pasture Hay

| | |
|---|---|
| ME | Crude Protein % |

| DMD % | MJ/kg | >19 | 14-19 | 8-13.9 | <8 |
|---|---|---|---|---|---|
| >66 | <9.5 | A1 | A2 | A3 | A4 |
| 60-66 | 8.5-9.4 | B1 | B2 | B3 | B4 |
| 53-59.9 | 7.4-8.4 | C1 | C2 | C3 | C4 |
| <53 | <7.4 | D1 | D2 | D3 | D4 |

Table 3 shows the Australian Fodder Industry Association Grades for Cereal Hay

| | |
|---|---|
| ME | Crude Protein % |

| DMD % | MJ/kg | >10 | 8-10 | 4-7.9 | <4 |
|---|---|---|---|---|---|
| >66 | <9.5 | A1 | A2 | A3 | A4 |
| 60-66 | 8.5-9.4 | B1 | B2 | B3 | B4 |
| 53-59.9 | 7.4-8.4 | C1 | C2 | C3 | C4 |
| <53 | <7.4 | D1 | D2 | D3 | D4 |

Table 4 below shows “mean and range” of systematic harvesting according to the present invention of Lucerne samples for maximum potency from 1st Dec. 05 to 10th Apr. 06.

TABLE 4

| De | | | | | ME | |
|---|---|---|---|---|---|---|
| scrip- | No. of | | | DMD | (MJ/kg | |
| tion | Samples | | CP (%) | (%) | DM) | NDF (%) |
| Hay - | 16 | Mean | 30.6 | 76.9 | 11.6 | 26.9 |
| Leg- | | Range | 25.4-35.3 | 72.0-79.8 | 10.8-12.1 | 18.2-32.0 |
| ume | | | | | | |

As can be seem from a comparison of the information in Table 4 with that in Table 1, that the Hay harvested according to the method of the present invention shows dramatically and easily identifiable increases in all four quality measurements. It can also be seen from Tables 2 and 3 that the Hay harvested according to the present invention would fall into the A1 category for both Legume and Pasture Hay and Cereal Hay.

The following is a schedule of herbs, which the inventor believes would benefit from the methodology of the present invention:

| | | |
|---|---|---|
| Abscess Root | Acacis | Acacia Bark |
| Acacia Catechu | Acacia (false) | Acacia (gum) |
| Aconite | Adder's Tongue (American) | Adder's Tongue |
| | | (English) |
| Adonis | Adrue | Agar-Agar |
| Agaric | Agave | Agrimony |
| Agrimony (Hemp) | Agrimony (Water) | Alder, Black American |
| Alder, Common | Alder Buckthorn | Alder, Tag |
| Alecost | Alexanders | Alkanets |
| Allspice | Almonds | Aloes |
| Alstona | Alstonia Bark | Amaranths |
| Amaranth, Wild | Ammoniacum | Anachusa |
| Anemones | Anemone Pulsatilla | Anemone (Wood) |
| Angelica | Angelica Tree | Angostura (True) |
| Anise | Anise (Star) | Annatto |
| Antirrhinum | Apple | Apple (Balsam) |
| Apple (Bitter) | Apple, Custard | Aploppas |
| Apocyrum | Apricot | Aralias |
| Araroba | Arbutus (Strawberry Tree) | Arbutus, Trailing |
| Archangel | Areca Nut | Arenaria Rubra |
| Arnica | Arrachs or Oraches | Arrach (Garden) |
| Arrach (Halberd-Leaved) | Arrach (Wild) | Arrowhead |
| Arrowroot | Artichoke, Jerusalem | Artichoke, Globe |
| Artichoke, Chinese | Artichoke, Cardoon | Arum |
| Asafetida | Asarabacca | Asclepias |
| Ash | Ash, Bitter | Ash, Manna |
| Ash, Mountain | Ash, Prickly | Ash, Wafer |
| Asparagus | Asphodel | Aubergine |
| Auricula | Avens | Avens (Mountain) |
| Avens, Water | Azadirachta | Bael |
| Balm | Balm of Gilead | Balmony |
| Balsam of Gilead | Balsam of Peru | Balsam of Tolu |
| Balsam, White | Bamboo Brier | Banana |
| Baneberry | Barberry, Common | Barberry, Nepal |
| Barberry (Indian) | Barley | Bartsia, Red |
| Basil, Bush | Basil, Sweet | Basil, Wild |
| Bayberry | Bean, Kidney | Bearberry |
| Bearsfoot (American) | Bearsfoot (British) | Bedstraw, Lady's |
| Bedstraw (Hedge) | Beech | Beetroots |
| Belladonna | Benne | Benzoin |
| Bergamot | Betel | Bethroot |
| Betony, Wood | Betony, Water | Bilberry |
| Bindweeds | Bindweed, Greater | Bindweed, Jalap |
| Bindweed, Sea | Bindweed, Syrian | Birch, Common |
| Birthwort | Bistort | Bitter Apple |
| Bitter Root | Bittersweet | Blackberry |
| Blackberry, American Black | Black Haw | Black Root |
| Current | | |
| Bladderwrack | Blites | Blite, Sea |
| Blite, Annual Sea | Blite, Strawberry | Bloodroot |
| Bluebell | Blue Flag | Blue Mallow |
| Bogbean | Boldo | Boneset |
| Borage | Box | Boxwood, American |
| Brooklime | Broom | Broom, Butcher's |
| Broom, Dryer's | Broom, Spanish | Broom-Corn |
| Bryony, Black | Bryony, European White | Bryony, White |
| Buchu | Buckbean | Buckthorns |
| Buckwheat | Bugle, Common | Bugle, Yellow |
| Bugleweed | Bugloss, Viper's | Bullace |
| Burdock | Burnet, Great | Burnet, Lesser |
| Burnet Saxifage | Burning Bush | Burr Marigold |
| Burra Gookeroo | Butcher's Broom | Butter Snakeroot |
| Butterbur | Buttuercup, Bulbous | Butternut |
| Cabbage Tree | Cacao | Cactus |
| Cajuput | Calabar Bean | Calamint |
| Calamus Aromaticus | Calisaya | Calotopis |
| Calumba | Camellia | Campanula |
| Camphor | Campion | Canadian Hemp |
| Canchalagua | Candytuft, bitter | Canella |
| Capsicum | Caraway | Cardamoms |
| Cardoons | Caroba | Carrot |
| Carrot, Wild | Cascara, Amarga | Cascara Sagrada |
| Cascarilla | Cashew Nut | Cassava |
| Cassia (Cinnamon) | Castor Oil Plant | Catechu, Pale |
| Catechu Pallidum | Catechu, Black | Catmint |
| Catnep | Catsfoot | Caulophyllum |
| Cayenne | Cedar, Yellow | Cedron |
| Celandine, Greater | Celandine, Lesser | Celery (Wild) |
| Centaury | Centaury, Chilian | Cereus, Night Blooming |
| Chammoniles | Chaste Tree | Chaulmoogra |
| Cheken | Chenopodiums | Cherry Laurel |
| Cherry Stalks | Cherry, Wild | Cherry, Winter |
| Chestnut, Horse | Chestnut, Sweet | Chickweed |
| Chicory | Chimaphila | China |
| Chiretta | Chives | Chrysanthemum |
| Cicely, Sweet | Cineraria Maritima | Cinnamon |
| Cinnamon, White | Cinquefoil | Clary, Common |
| Clematis | Clivers | Clover, Red |
| Cloves | Club Moss | Coca, Bolivian |
| Cocculus, Indicus | Cocillana Bark | Cocklebur |
| Coffee | Cohosh, Black | Cohosh, Blue |
| Colchicum | Cole Seed | Colocynth |
| Coltsfoot | Columbine | Columbo, American |
| Combretum | Comfrey | Compass Plant |
| Condurango | Contrayerva | Convolvulus, Field |
| Coolwort | Copaiba | Coriander |
| Corkwood Tree | Corn Cockle | Cornflower |
| Corn, Indian | Corn Salad | Corn Silk |
| Corsican Moss | Costmary | Coto |
| Cotton Root | Couchgrass | Cowhage |
| Cowslip | Cow-Wheat | Cramp Bark |
| Cranesbill Root, American | Crawley Root | Crosswort |
| Croton | Crowfoot, Celery-Leaved | Crowfoot, Upright |
| | | Medow |
| Cubebs | Cuckoo-pint | Cucumber |
| Cucumber, Squirting | Cudbear | Cudweed |
| Cumin | Cup Moss | Cup Plant |
| Curare | Currant, Black | Currant, Red |
| Cyclamen, Ivy-Leafed | Daffodil | Dahlias |
| Daisy, Common | Daisy, Ox-Eye | Damiana |
| Damiana, False | Damson | Dandelion |
| Datura | Deer's Tongue | Delphinium |
| Devil's Bit | Dill | Dita Bark |
| Docks | Dodder | Dog Rose |
| Dog's Mercury | Dogwood, Jamaica | Dragon's Blood |
| Dropwort, Hemlock Water | Dropwort, Water | Dyer's Greenweed |
| Dyer's Madder | Echinacea | Egg Plant |
| Elaterium | Elder | Elder, Dwarf |
| Elder, Dwaft, American | Elecampane | Elm, Common |
| Elm, Slippery | Embelia | Ephedra |
| Ergot | Eryngo | Eucalyptus |
| Euonymus | Eupatoriums | Euphorbia, Euphorbium |
| Evening Primrose | Everlasting Flowers | Eyebright |
| Fennel | Fennel, Dog | Fennel, Florence |
| Fennel Flower | Fennel, Hog's | Fennel (Water) |
| Fenugreek | Ferns | Fever Bush |
| Feverfew | Feverfew (Corn) | Fig, Common |
| Figwort, Knotted | Figwort, Water | Fireweed |
| Firs | Fleur De Luce | Fluellin |
| Fool's Parsley | Five-Leaf Grass | Flag (Blue) |
| Flag (Yellow) | Flax | Flax, Mountain |
| Flax, Perennial | Fleabane, Canadian | Fleabane, Common |
| Fleabane, Great | Forget-Me-Not | Foxglove |
| Frankincense | Fringe Tree | Fritillary, Common |
| Frostwort | Fuchsia | Fumitory |
| Fungi | Galangal | Galbanum |
| Gale, Sweet | Galls | Gamboge |
| Garlic | Gelsemium | Gentians |
| Geranium | Germander, Sage-Leaved | Germander, Wall |
| Germander, Water | Ginger | Ginger, Wild |
| Ginseng | Gipsyweed, Common | Gladwyn, Stinking |
| Glassworts | Gleditschia | Globe Flower |
| Gnaphaliums | Goa | Goat's Beard |
| Goat's Rue | Gold Thread | Golden Rod |
| Golden Seal | Good King Henry | Gooseberry |
| Goosefoots | Gorse, Golden | Goutweed |
| Grape, Mountain | Grasses | Gravelroot |
| Greenwood (Dyers') | Grindelia | Ground Ivy |
| Ground Pine (American) | Ground Pine (European) | Groundsel, Common |
| Guaiacum | Guarana | Guelder Rose |
| Hair Cap Moss | Hardhack | Hart's Tongue |
| Hawkbit, Autumnal | Hawkbit, Rough | Hawkweed, Wall |
| Hawkweed, Wood | Hawkweed, Mouse-Ear | Hawthorn |
| Heartsease | Hedge-Hyssop | Hedge Mustard |
| Heliotrope | Hellebore, Black | Hellebore, False |
| Hellebore, Green | Hellebore, White | Hemlock |
| Hemlock, Water | Hemp, Enc. Britannica, 1856 | Hemp, Agrimony |
| Hemp, Canadian | Hemp, Indian | Henbane |
| Henna | Hepatica | Herb Paris |
| Hog's Fennel | Holly | Holly, Sea |
| Hollyhock | Honeysuckles | Hops |
| Horehound, White | Horehound, Black | Horse Chestnut |
| Horsemint | Horsenettle | Horseradish |
| Horsetails | Hound's Tongue | Houseleek |
| Hyacinth, Grape | Hyacinth, Wild | Hydnocarpus |
| Hydrangea | Hydrocotyle | Hydrophilia |
| Hyssop | Hyssop, Hedge | Hysteronica |
| Iceland Moss | Ignatius Beans | Indian Hemp |
| Indian Physic | Indigo | Indigo (Wild) |
| Ipecacuanha | Irises | Iris Pseudacorus |
| Iris Tenax | Iris Versicolor Irish Moss | Ispaghul |
| Ivy, American | Ivy, Common | Ivy, Ground |
| Ivy, Poison | Jaborandi | Jacob's Ladder |
| Jalap | Jamaica Dogwood | Jambul |
| Jasmines | Jequirity | Jewelwood |
| John's Bread | Jujube Berries | Juniper Berries |
| Kamala | Kava Kava | Kidneywort |
| Kinos | Knapweed, Black | Knapweed, Greater |
| Knapwort Harshweed | Knotgrass | Knotgrass, Russian |
| Kola Nuts | Kousso | Labrador Tea |
| Laburnum | Lachnenthes | Ladies's Bedstraw |
| Lady's Mantle | Lady's Slipper | Lady's Trusses |
| Larch | Larkspur, Field | Laurel (Bay) |
| Laurel, Cherry | Laurel, Mountain | Lavenders |
| Lavender Cotton | Lavender, Sea, American | Lemon |
| Lettuce, Wild | Life Everlasting (Pearl- | Life Root |
| | Flowered) | |
| Lilacs (White and Mauve) | Lilies | Lily, Crown Imperial |
| Lilly-of-the-Valley | Lily, Modonna | Lily, Tiger |
| Lily, White Pond | Lime Fruit | Lime Tree |
| Linseed | Lippia | Lippia Citriodora |
| Liquorice | Liquorice, Indian | Liquorice, Wild |
| Litmus | Liverwort, American | Liverwort, English |
| Lobelia | Logwood | Loosestrife, Purple |
| Loosestrife, Yellow | Lovage | Lovage, Bastard |
| Lovage, Black | Lovage, Scotch | Lovage, Water |
| Love Lies Bleeding | Lucerne | Lungwort |
| Lupins | Mace | Madder |
| Magnolia | Maidenhair | Malabar Nut |
| Male Fern | Mallows | Manaca |
| Mandioca | Mandrake | Mandrake, American |
| Manna | Manzanillo | Maples |
| Mare's Tail | Marigold | Marigold, Bur |
| Marigold, Marsh | Marjoram, Sweet | Marjoram, Wild |
| Marijuana (Hemp, Indian) | Marshmallow | Masterwort |
| Mastic | Matico | Matte Tea |
| Mayweed | Mayweed, Scentless | Meadowsweet |
| Melilot | Melons | Mercury, Dog's |
| Mercury, Annual | Mescal Buttons | Mezereon |
| Milfoil | Milfoil, Water | Milkweed |
| Mimosas | Mints | Mistletoe |
| Momordica | Moneywort | Monsonia |
| Morning Glory | Moschatel, Common | Mosquito Plant |
| Moss, American Club | Moss, Common Club | Moss, Corsican |
| Moss, Cup | Moss, Hair Cap | Moss, Iceland |
| Moss, Irish | Moss, Sphagnum | Motherwort |
| Mountain Ash | Mountain Flax | Mountain Grape |
| Mountain Laurel | Mouse-Ear | Mugwort |
| Mulberry, Common | Mullein, Great | Musk Seed |
| Mustards | Myrrh | Narcissus |
| Nasturtium | Nettles | Nightshade, Black |
| Nightshade, Deadly | Nightshade, Woody | Nutmeg |
| Nux Vomica | Oak, Common | Oak, of Oats |
| Oleander | Olibanum | Olive |
| Onion | Onion, Potato | Onion, Tree |
| Opoponax | Orange, Bitter | Orange, Sweet |
| Orchids | Osier, Red American | Osier, Green |
| Ox-eye Daisy | Ox-tongue | Paeony |
| Papaw | Papaw Seeds | Paradise Gains |
| Paraguay Tea | Pareira | Parilla, Yellow |
| Paris, Herb | Parsley | Prasley, Fool's |
| Parsley Piert | Parsnip | Parsnip, Water |
| Passion Flower | Patchouli | Papyrus |
| Peach | Pelargoniums | Pellitory |
| Pellitory, Dalmatian | Pellitory, Persian | Pellitory-of-the-Wall |
| Pennyroyal | Pepper | Pepper, Hungarian |
| Peppermint | Periwinkles | Peruvian Balsam |
| Peruvian Bark | Pheasant's Eye | Pichi |
| Pilewort | Pimpernel, Scarlet | Pine |
| Pine (Larch) | Pine, White | Pine, (Ground) |
| Pine, American Ground | Pink Root | Pinus Bark. Hemlock |
| | | Spruce |
| Pipsissewa | Pitcher Plant | Plantain, Common |
| Plantain, Buck's Horn | Plantain, Hoary | Plantain, Ispaghul |
| Plantain, Psylllium | Plantain, Ribwort | Plantain, Sea |
| Plantain, Water | Plantain, Fruit | Pleurisy Root |
| Ploughman's Spikenard | Plumbago | Poison Ivy |
| Poison Oak | Poke Root | Polypody Root |
| Polyporus of Larch | Pomegranate | Poplar, trembling |
| Poppy, Plume | Poppy, Red | Poppy, White |
| Potato | Potato, Prairie | Potato, Wild |
| Prickly Ash | Primrose | Primrose, Evening |
| Primulas | Prunes | Psyllium Seeds |
| Pulsatilla | Pumpkin | Purslane, Green |
| Purslane, Golden | Pyrolas | Quassia |
| Quebracho | Queen's Delight | Quince |
| Quince, Japaese | Quinoa | Quinsy-Wort |
| Radish | Ragwort | Rampion |
| Rape Seed | Raspberry | Rattle, Dwarf Red |
| Rattle, Yellow | Red Clover | Red Root |
| Red Sage | Rest-Harrow | Rhatany |
| Rhododendron, Yellow | Rhubarbs | Rice |
| Rocket, Garden | Rosemary | Roses |
| Rosin-Weed | Rue | Rue, Goat's |
| Rushes | Rupturewort | Sabadilla |
| Safflower | Saffron | Saffron, Meadow |
| Sages | St. John's Wort | Salep |
| Salsafy | Salvias | Samphire |
| Samphire Golden | Sandalwood | Sandspurry, Common |
| Sanicle, Wood | Sarsaparilla, American | Sarsaparilla, Caracao |
| Sarsaparilla, Jamaica | Sarsaparilla, Indian | Sarsaparilla, Wild |
| Sassafras | Sassy Bark | Saunders, Red |
| Savine | Savory, Summer | Savory, winter |
| Saw Palmeto | Saxifrage, Burnet | Saxifrage, Greater |
| | | Burnet |
| Scabious, Field | Scabious, Lesser | Scabious, Devils's Bit |
| Scammony | Scopolia | Scullcaps |
| Scurvy Grass | Sea Fennel | Sea Lavender |
| Seaweed | Sedge, Sweet | Self-Heal |
| Senega | Senna | Senna, Bladder |
| Sensitive Plant | Shallot | Sheep's Sorrel |
| Shepherd's Purse | Siegesbeckia | Silverweed |
| Simaruba | Skirret | Skunk-Cabbage |
| Slippery Elm | Smartweed | Smilax, China |
| Snakeroot | Snakeroot, Button | Snapdragon |
| Snowdrop | Soap Tree | Soapwort |
| Soapwort Root, Egyptian | Solamon's Seal | Sorrel, Common |
| Sorrel, French | Sorrel, Mountain | Sorrel, Sheep's |
| Sorrel, Wood | Southernwood | Southernwood, Field |
| Sow-Thistles | Spaghnum | Spearmint |
| Spearwort, Lesser | Speedwell, Common | Speedwell, Germander |
| Spikenard, American | Spikenard, Californian | Spikenard, Ploughman's |
| Spinach | Spinach, New Zealand | Spindle Tree |
| Spergularia | Spurges | Squaw Vine |
| Squill | Squirting Cucumber | Star Anise |
| Star of Bethlehem | Stavasacre | Stonecrops |
| Stone Root | Storax | Stramonium |
| Strawberry | Strophanthus | Sumachs |
| Sumbul | Sundew | Sunflower |
| Swamp Milkweed | Tag Alder | Tallow Tree |
| Tamarac | Tamarinds | Tansy |
| Tapioca | Tarragon | Tea |
| Teazles | Thapsia | Thistles |
| Thornapple | Thuja | Thyme, Basil |
| Thyme, Cat | Thyme, Garden | Thyme, Wild |
| Tiger Lily | Toadflax | Toadflax, Ivy-Leaved |
| Tobacco | Tolu Balsam | Tonka Beans |
| Tonquin Bean | Tormentil | Tragacanth |
| Traverllers' Joy | Tree of Heaven | Turkey Corn |
| Turmeric | Turpeth | Unicorn Root, False |
| Unicorn Root, True | Uva Ursi | Valerian |
| Valerian, American | Valerian, Indian | Valerian, Red-Spur |
| Verbena, Lemon | Vernal Grass, Sweet | Veronicas |
| vervain | Vine | Violet, Dog |
| Violet, Hairy | Violet, Sweet | Violet, Water |
| Virginia Creeper | Wafer Ash | Wahoo |
| wake Robin, American | Wallflower | Wall Rue |
| Walnut | Walnut, White | Water Betony |
| Watercress | Water Dock | Water Dropwort |
| Water Fennel | Water Soldier | White Pond Lily |
| Wild Carrot | Wild Cherry | Wild Ginger |
| Wild Indigo | Wild Yam | Wild Mint |
| Willow, Black American | Willow, White | Willow-Herbs |
| Wintergreen | Winter's Bark | Winter's Bark, False |
| Witch Hazel | Woad | Wood Anemone |
| Wood Betony | Woodruff, Sweet | Wood Sage |
| Wood Sanicle | Wood Sorrel | Wormseed, American |
| Wormseed, Lavant | Wormwoods | Woundwort, Hedge |
| Woundwort, Marsh | Yam, Wild | Yarrow |
| Yellow Dock | Yellow Flag | Yellow Parillia |
| Yerba Reuma | Yerba Santa | Yew |
| Zeodary | | |

In the present specification and claims, the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A method of cultivating plants including the step of harvesting the plant at a time within a period of 5 days prior to a lunar apogee and 5 days after the lunar apogee in any given cycle.

2. A method according to claim 1 wherein the plant life cycle is managed for systematic harvesting within the period of 5 days prior to a lunar apogee and 5 days after the lunar apogee.

3. A method according to claim 2 wherein the life cycle of the plant is managed such that planting takes place within a period from the new moon and 10 days after a new moon.

4. A method according to claim 1 wherein harvesting takes place within a period of 3 days prior to a lunar apogee and 3 days after the lunar apogee.

5. A method according to claim 1 wherein harvesting takes place within a period of 1 day prior to a lunar apogee and 1 day after the lunar apogee.

6. A method according to claim 1 wherein harvesting takes place on the day of the lunar apogee.

7. A method of cultivating plants according to claim 1 wherein the step of harvesting the plant further takes place within a period of 5 days prior to a full moon and 5 days after a full moon.

8. A method according to claim 1 further including the steps of planting the plant and calculating the harvesting time of a mature plant to coincide with the period of 5 days prior to a lunar apogee and 5 days after the lunar apogee in any given cycle.

9. A method according to claim 1 wherein harvesting takes place on a lunar apogee chosen to maximise the distance of the moon from the earth.

10. A method according to claim 1 wherein harvesting also takes place after moonset and prior to moonrise during a daily cycle.

11. A method according to claim 1 wherein harvesting occurs at approximately a time during a daily cycle coinciding approximately with a reflex tide.

12. A method according to claim 1 wherein harvesting takes place during a period after moonset and prior to moonrise during a daily cycle, and within a period of 5 days prior to a full moon and 5 days after a full moon.
